(19) United States
(12) Patent Application Publication
(10) Pub. No.: US 2006/0219205 A1
(43) Pub. Date: Oct. 5, 2006

(54) Air compression internal combustion engine

(76) Inventors: Josef Astner, Kernen (DE); Ulrich Engel, Plochingen (DE); Bernhard Jutz, Burgstetten (DE); Edwin Zink, Karlsruhe (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 11/399,685

(22) Filed: Apr. 6, 2006

Related U.S. Application Data
(63) Continuation-in-part of application No. PCT/EP04/10050, filed on Sep. 9, 2004.

(30) Foreign Application Priority Data
Oct. 9, 2003 (DE) 103 46 889.7

(51) Int. Cl. F02B 75/02; F02B 15/00; F02F 1/42

(52) U.S. Cl. 123/193.5; 123/315; 123/432

(57) ABSTRACT

In an air compression internal combustion engine having at least one cylinder, a combustion chamber formed in the cylinder and delimited at its longitudinal ends by a piston and a cylinder head which covers the cylinder, two intake valves and two exhaust valves per cylinder are installed in the cylinder head so as to be inclined at a valve angle α and β, respectively, in the range of 2° to 9° relative to a cylinder head longitudinal central plane (10), the valves each have a valve diameter Dᵢₙₜₐₖₑ and Dₑₓₕₐᵤₛₜ which is 30% to 40% of the cylinder diameter D_{cylinder}, the valve heads are disposed at a distance from the cylinder wall which delimits the combustion chamber, and webs of a predefined width are provided between adjacent valves of a cylinder, and the valve heads have sections which protrude into the combustion by a predetermined limited amount.

This is a Continuation-In-Part Application of International Application PCT/EP2004/010050 filed Sep. 9, 2004 and claiming the priority of German Application 103 49 889.7 filed Oct. 9, 2003.

### BACKGROUND OF THE INVENTION

The invention relates to an air compression internal combustion engine having at least one cylinder arranged in an engine block, a combustion chamber which is formed in the cylinder and is delimited at its longitudinal ends by a piston and a cylinder head which covers the engine block. There are four gas exchange valves per cylinder which are in each case installed in the cylinder head so as to be inclined at a valve angle in the range from 2° to 9° relative to a cylinder head longitudinal central plane. The gas exchange valves each have a valve diameter which is 30% to 40% of the cylinder diameter, and the valve heads, which are situated in the base of the cylinder head, also are disposed at a distance from the cylinder walls.

An air compression internal combustion engine of such a type is known from MTZ Motortechnische Zeitschrift 58 (1997) pages 652 to 659. The internal combustion engine is equipped with two intake valves and two exhaust valves per cylinder. Here, the intake valves in the cylinder head are arranged on one side of the cylinder heads longitudinal central plane and the exhaust valves are arranged on the opposite side. Each gas exchange valve is arranged such that it is laterally outwardly inclined by a small valve angle of approximately 2° to 9° relative to the cylinder head longitudinal central plane. Depending on the cylinder diameter, the gas exchange valves have a valve diameter, measured at the valve head, of approximately 30% to 40% of the cylinder diameter.

In addition, the internal combustion engine is provided with a common rail fuel injection system, including fuel injectors which extend centrally into the combustion chamber.

The characteristic engine values specified in the MTZ report however are not sufficient as design parameters for air compression internal combustion engines for achieving optimum combustion and strength values.

It is the object of the present invention to provide design parameters generically for air compression internal combustion engines, with the aid of which design configurations for an internal combustion engine having optimum swirl and throughflow characteristic values and also good mechanical strength can be obtained.

### SUMMARY OF THE INVENTION

In an air compression internal combustion engine having at least one cylinder, a combustion chamber formed in the cylinder and delimited at its longitudinal ends by a piston and a cylinder head which covers the cylinder, two intake valves and two exhaust valves per cylinder are installed in the cylinder head so as to be inclined at a valve angle α and β, respectively, in the range from 2° to 9° relative to a cylinder head longitudinal central plane, the valves each have a valve diameter Dᵢₙₜₐₖₑ and Dₑₓₕₐᵤₛₜ which is 30% to 40% of the cylinder diameter D_{cylinder}, the valve heads are disposed at a distance from the cylinder wall which delimits the cylinder, and webs of a predefined width are provided between adjacent valves of a cylinder, and the valve heads have sections which protrude into the combustion by a predetermined amount.

The design parameters constitute a balanced compromise with regard to obtaining both optimum swirl and throughflow characteristic values and also permissible mechanical loads. The design parameters are also suitable for optimizing the valve projection, that is to say, the lift of sections of the valve heads into the combustion chamber. As a result, both, an excessively large valve lift which requires excessively large valve accommodation recesses in the piston base and adversely affects combustion, and an excessively small valve lift, which results in large clearance volumes in the combustion chamber and poor throughflow values, are avoided. Finally, the design parameters provide for a favorable distance of the individual gas exchange valves from the cylinder wall so that disadvantages in swirl and throughflow behavior are avoided.

The structural parameters according to the invention for a multi-cylinder head of an air compression internal combustion engine are illustrated by way of example in the accompanying drawing:

### BRIEF DESCRIPTION OF THE DRAWINGS

FIG. 1 shows the cylinder head in a cross section taken along the line I-I of FIG. 2, and

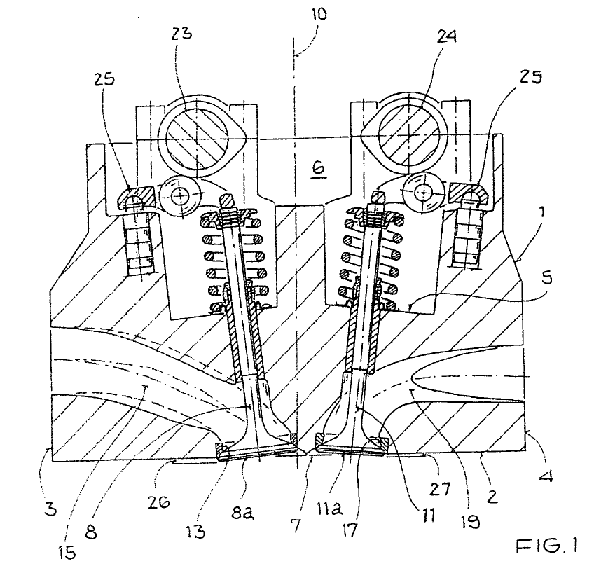

FIG. 2 shows is a bottom view of the cylinder head.

### DESCRIPTION OF A PREFERRED EMBODIMENT

In the figures a cylinder head housing for a multi-cylinder air compression internal combustion engine is denoted by 1. The cylinder head housing 1 is delimited by a cylinder head bottom face 2, two side walls 3, 4 and a top face 5, in which a control space 6 for holding a valve train is provided.

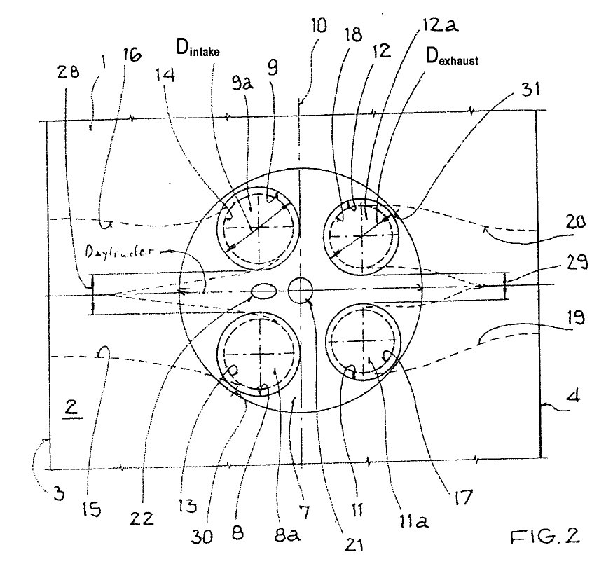

Part of the cylinder head bottom face 2 forms a combustion chamber section 7 which covers a cylinder in an engine block (not illustrated). In FIG. 2, the combustion chamber section 7 is shown delimited by a circle which corresponds to the cylinder diameter “Dcylinder”. The internal combustion engine has four gas exchange valves per cylinder, which gas exchange valves are arranged within the combustion chamber section 7 in such a way that the two intake valves 8 and 9 are positioned to the left of a vertical cylinder head longitudinal central plane 10 and the two exhaust valves 11 and 12 are positioned to the right of the latter. The intake valves 8 and 9 control, by means of their associated valve heads 8a and 9a, intake valve openings 13 and 14, from which corresponding intake ducts 15 and 16 extend toward the side wall 3. In a corresponding manner, the exhaust valves 11 and 12 control, by means of their associated valve heads 11a and 12a, exhaust valve openings 17 and 18, from which the exhaust ducts 19 and 20 extend and pass through the cylinder head to the side wall 4.

A centrally situated opening 21 for accommodating an injector for directly injecting fuel, in particular diesel fuel, into the combustion chamber, and a bore 22 for a glow plug are provided in the cylinder head within the combustion chamber section 7.

The intake valves 8, 9 are actuated by an intake camshaft 23 and the exhaust valves 11, 12 are actuated by an exhaust camshaft 24, in each case via rocker arms 25 positioned in between the valves and the respective camshaft.

So that both camshafts 23 and 24 can be accommodated within the cylinder head housing 2, the gas exchange valves are arranged so as to be inclined relative to the cylinder head longitudinal central plane 10 in a V-shape.

Here, the intake valves 8, 9 are inclined at a valve angle α of approximately 2° to 9°, and the exhaust valves 11, 12 are inclined at a valve angle β of likewise 2° to 9°.

In connection with the invention, different valve angles are also conceivable. As a result of the inclined arrangement of the gas exchange valves, the intake valve openings 13, 14 and the exhaust valve openings 15, 16 formed in the cylinder head base are likewise in inclined. Because of this inclination pocket-shaped recesses, which constitute a clearance volume within the combustion chamber configuration, are formed at those sections of the individual valve openings which are adjacent to the cylinder head longitudinal central plane 10. This clearance volume has an influence on the combustion and also swirl and throughflow characteristic values of the cylinder.

In addition, as a result of the V-shaped valve arrangement, the laterally outwardly situated sections of the valve heads 8a, 9a and 11a, 12a have portions Üᵢₙₜₐₖₑ 26 and Üₑₓₕₐᵤₛₜ 27 projecting into the combustion chamber. These projections at the valve heads likewise have an influence on the swirl and throughflow characteristic values of an internal combustion engine, as do the distances Aᵢₙₜₐₖₑ 30 and Aₑₓₕₐᵤₛₜ 31 of the valve heads from the cylinder wall.

With regard to the mechanical strength of a cylinder head, both the diameters of the gas exchange valves and the width of the web between the gas exchange valves are decisive factors. In FIG. 2, the web between the intake valves 8, 9 is denoted by the numeral 28 and the web between the exhaust valves 11, 12 is denoted by the numeral 29.

For an air compression direct-injection internal combustion engine having four gas exchange valves per cylinder, with regard to the configuration of a combustion chamber, optimum swirl and throughflow values for gas exchange with simultaneously optimum values for mechanical strength are obtained if the following design parameters are incorporated:
Intake valve diameter Dᵢₙₜₐₖₑ=34% to 36% of the cylinder diameter D_{cylinder};
Exhaust valve diameter Dₑₓₕₐᵤₛₜ=30% to 32% of the cylinder diameter D_{cylinder};
Valve angle α or β=4° to 7°;
Distance of the valve heads of the gas exchange valves from the cylinder wall=1.5 mm to 2.0 mm;
Maximum projection Üᵢₙₜₐₖₑ and Üₑₓₕₐᵤₛₜ from the cylinder head base face=0.1 mm to 0.7 mm.

What is claimed is:

1. An air compression internal combustion engine having at least one cylinder arranged in an engine block with a combustion chamber formed in the cylinder and being delimited at its longitudinal ends by a piston and a cylinder head (1) which has a bottom area covering the cylinder, the cylinder head including for each cylinder four gas exchange valves (intake valves 8, 9 and exhaust valves 11, 12) which are installed in the cylinder head (1) so as to be inclined at a valve angle α and β, respectively, each in the range of 2° to 9° relative to a cylinder head longitudinal central plane (10), the gas exchange valves each having valve heads (8a, 9a, 11a, 12a) with diameters Dᵢₙₜₐₖₑ and Dₑₓₕₐᵤₛₜ which have a diameter of 30% to 40% of the cylinder diameter D_{cylinder}, and the valve heads (8a, 9a, 11a, 12a) which are seated at the bottom of the cylinder head (1) also being disposed at a distance (30, 31) from the cylinder wall which delimits the combustion chamber, a web (28, 29) of a predefined width additionally being provided between adjacent gas exchange valves of a cylinder, and sections of the valve heads (8a, 9a, 11a, 12a) of all the gas exchange valves having projection (26, 27) protruding into the combustion chamber.

2. The air compression internal combustion engine as claimed in claim 1, wherein the gas exchange valves have diameters Dᵢₙₜₐₖₑ and Dₑₓₕₐᵤₛₜ in the range of 30% to 36% of the cylinder diameter D_{cylinder}.

3. The air compression internal combustion engine as claimed in claim 2, wherein the intake valves (8, 9) have diameters Dᵢₙₜₐₖₑ of 34% to 36% of the cylinder diameter D_{cylinder} and the exhaust valves (11, 12) have diameters Dₑₓₕₐᵤₛₜ of 30% to 32% of the cylinder diameter D_{cylinder}.

4. The air compression internal combustion engine as claimed in claim 1, wherein the distance of the gas exchange valves (8, 9, 11, 12) from the cylinder wall is 1.5 mm to 2.0 mm.

5. The air compression internal combustion engine as claimed in claim 1, wherein the web (28) between the intake valves (8, 9) has a width of at least 5 mm.

6. The air compression internal combustion engine as claimed in claim 1, wherein the web (29) between the exhaust valves (11, 12) has a width of at least 7 mm.

7. The air compression internal combustion engine as claimed in claim 1, wherein the projection (30, 31) of the sections of the valve heads (8a, 9a, 11a, 12a) which protrude into the combustion chamber when the valves are closed is 0.1 mm to 0.7 mm.
